(19) United States
(12) Patent Application Publication
(10) Pub. No.: US 2026/0049965 A1
(43) Pub. Date: Feb. 19, 2026

(54) SURFACE WAVE SENSOR DEVICE

(71) Applicant: Technische Universität Wien, Wien (AT)

(72) Inventors: Hendrik Kähler, Wien (AT); Silvan Schmid, Wien (AT); Holger Arthaber, Wien (AT)

(21) Appl. No.: 19/101,831

(22) PCT Filed: Aug. 7, 2023
(86) PCT No.: PCT/EP2023/071855

§ 371 Date: Feb. 6, 2025

(30) Foreign Application Priority Data
Aug. 8, 2022 (AT) A50602/2022

(51) Int. Cl. G01N 29/12; G01N 29/04

(52) U.S. Cl. CPC G01N 29/12; G01N 29/041; G01N 2291/014; G01N 2291/0423

(57) ABSTRACT

The invention relates to a sensor device which has a carrier material, in particular a piezoelectric carrier material. Furthermore, the sensor device comprises at least one interdigital transducer, which is configured as a transmitter (IDTs) and as a receiver (IDTe) and is arranged on the carrier material, or at least one interdigital transducer, which is configured as a transmitter (IDTs) and at least one interdigital transducer, which is configured as a receiver (IDTe) and is also arranged on the carrier material. The sensor device further comprises at least one mechanical resonator (MR), which is arranged on the carrier material at a distance A from the IDTs and at a distance B from the IDTe, wherein the sensor device is set up so that a surface wave emitted by the IDTs as a transmit signal causes the MR to vibrate mechanically and a surface wave emitted by the vibrating MR travels as a receive signal in the direction of the IDTe and triggers a measurement signal in the latter.

In the field of micro-and nanotechnology, nanoelectromechanical resonators are increasingly being used as sensors (NEMS=nanoelectromechanical systems). The increased interest in NEMS-based sensors is based, among other things, on the fact that it is possible to manufacture the mechanical resonator of a NEMS in such a way that the sensor has specific properties for a measurement task and can also be customized for this purpose, which, however, requires a high degree of control over the mechanical properties of the resonator. These are, for example, the coherent control of the mechanical oscillations, the fine tuning of the coupling properties with other mechanical systems or with other physical degrees of freedom or the control of dissipative and non-linear effects.

Current areas of application include the highly sensitive measurement of forces, masses, gas concentrations and temperature.

Although the high sensitivity of NEMS is important in the field of mass spectrometry, its application is limited, particularly in this area. This is because NEMS cannot effectively capture the particles to be analyzed due to their small spatial extent. One approach to solving this problem is to use several individual mechanical resonators in a confined space. Such an arrangement of mechanical resonators on the NEMS substrate is called a two-dimensional array. Bargatin et al. describe an array in which thousands of individual mechanical resonators are arranged on a NEMS substrate (“Large-Scale Integration of Nanoeletromechanical Systems for Gas Sensing Applications”, Nano Lett. 2012 March 14; 12(3): DOI:10.1021/nl2037479). An array formed from twenty resonators is described by Sage et al. in, “Single-particle mass spectrometry with arrays of frequency-addressed nanomechanical resonators”, Nat Commun 9, 3283 (2018): DOI:10.1038/s41467-018-05783-4.

The excitation of the mechanical resonators arranged in isolation on the carrier material surface of a NEMS can be caused by surface acoustic waves (SAWs), which propagate through the carrier material surface and whose movement is transmitted to the resonators, causing them to vibrate mechanically. The spatial distribution of the elastic energy of the surface acoustic waves on the surface of the carrier material is influenced by the resonators. The elastic wave source can be realized in the form of an acoustic interdigital transducer. A corresponding NEMS with an array formed by seven different geometrical mechanical resonators driven by one of two wave sources arranged around the array is described by S. Benchabane et al. in “Surface-Wave Coupling to Single Phononic Subwavelength Resonators”, https://doi.org/10.1103/PhysRevApplied.8.034016.

Acoustic transducers are used here as the wave source, i.e. to generate the surface acoustic waves. A transducer is a transducer that converts an electrical wave received as an input signal into an acoustic wave and then emits it, e.g. into the surface of the carrier material on which the transducer is arranged. An interdigital transducer (IDT) is an acoustic transducer that comprises finger-like structures. These finger-like structures are called interdigital electrodes. They look like the prongs of two combs that interlock without touching each other. The finger-like structures are usually made of metal and are arranged on a piezoelectric carrier material. If an electrical voltage is applied between the combs, the mechanical force generated (piezoelectric effect) causes a change in the length of the carrier material between each pair of prongs. If an alternating voltage is applied, this mechanical force causes the carrier material to vibrate. As a result, surface acoustic waves are generated that propagate on the carrier material.

The mechanical resonators are often formed as cylindrical pillars, which are grown individually, for example, by focused ion beam-induced deposition on a piezoelectric carrier material and have different geometric parameters. The pillars can be excited by a long-wave elastic surface wave. The mechanical deflection of the resonators caused by the surface acoustic waves can be significantly stronger than the displacement fields of the surface acoustic waves due to resonance. In this context, Benchabane et al. report a tenfold amplification of the deflection compared to the oscillation at the surface.

Laser scanning interferometry is used to verify the displacement of the resonators. This measurement method has two disadvantages in particular. On the one hand, it is difficult to integrate due to the necessary optical setup, for example for the production of an integrated NEMS-based sensor, which should have a small spatial extension. Secondly, the optical detection method cannot be used to measure or read out the displacements of several resonators simultaneously, which is necessary for applications such as mass spectrometry. In contrast to the approach of Benchabane et al., the sensors of Bargatin and Sage do not have these disadvantages. Both use purely electrical methods to drive and read out the resonators. However, their purely electrical methods prevent the formation of dense arrays of resonators, as there is little space available for an array due to electrical leads that must be placed close to the resonators and are necessary to read out the resonators. The state of the art therefore has the disadvantage that the density of a two-dimensional array arrangement, i.e. the number of resonators and their distances from each other, is limited to array arrangements consisting of few resonators. However, in order to increase the efficiency of a NEMS-based mass sensor, for example, several resonators would have to be used in a confined space. It would therefore be advantageous if the density of the two-dimensional array could be increased by using a larger number of resonators. A dense two-dimensional array arrangement of mechanical resonators is understood in particular to be an array arrangement in which the resonators are less than 20 μm apart, i.e. for example from resonator center to resonator center or from resonator outer wall to resonator outer wall. For example, the resonators have a distance of less than 10 μm and/or less than 1 μm from each other.

It is therefore a task of the invention to provide a sensor device which enables the formation of dense two-dimensional arrays of mechanical resonators. Furthermore, it is a task of the invention to provide a sensor device in which several mechanical resonators can be read out individually and/or also together.

The problem is solved by the objects of the independent claims. Preferred embodiments are objects of the subclaims.

The sensor device according to the invention has a, in particular piezoelectric, carrier material; according to the first IDT arrangement, at least one interdigital transducer, which is set up as a transmitter (IDTs) and as a receiver (IDTe) and is arranged on the, in particular piezoelectric, carrier material; at least one, in particular micro-or nanomechanical resonator (MR), which is arranged at a distance A from the IDTs and at a distance B from the IDTe on the, in particular piezoelectric, carrier material, the sensor device being set up so that a surface wave emitted by the IDTs causes the MR to vibrate mechanically as a transmit signal and a surface wave emitted by the vibrating MR travels in the direction of the IDTe as a receive signal and triggers a measurement signal in the latter.

Alternatively, a sensor device according to the invention comprises: a carrier material, in particular a piezoelectric carrier material; according to the second IDT arrangement, at least one interdigital transducer which is set up as a transmitter (IDTs) and at least one interdigital transducer which is set up as a receiver (IDTe) and is arranged on the, in particular piezoelectric, carrier material, at least one, in particular micro-, mechanical resonator (MR) which is arranged at a distance A from the IDTs and at a distance B from the IDTe on the, in particular piezoelectric, carrier material, the sensor device being set up such that a surface wave emitted by the IDTs as a transmitter is arranged at a distance A from the IDTs and at a distance B from the IDTe on the, in particular piezoelectric, carrier material, the sensor device is set up so that a surface wave emitted by the IDTs causes the MR to vibrate mechanically as a transmit signal and a surface wave emitted by the vibrating MR travels in the direction of the IDTe as a receive signal and triggers a measurement signal in the IDTe.

A sensor device refers in particular to a sensor. A sensor, also known as a detector, (measurand or measurement) transducer or (measurement) probe, is a technical component that can detect certain physical or chemical properties (physically, e.g. mass, temperature, humidity, pressure, sound field quantities, acceleration or chemically, e.g. pH value, ionic strength, electrochemical potential) and/or the material properties of its environment qualitatively or quantitatively as a measurand. These variables are recorded by means of physical, chemical or biological effects and converted into a signal that can be further processed, in particular an electrical signal. A NEMS can be understood to mean a sensor device according to the invention.

In measurement technology, the term transducer (measured variable transducer) is used and defined as the part of a measuring device that responds directly to a measured variable. The transducer is therefore the first element of a measuring chain. The transducer is one of the measuring transducers, and with the same physical quantity at the input and output it is also a measuring transducer.

The distinction between the terms sensor and transducer, measuring probe, measuring device, measuring equipment, etc. is fluid, as other elements of the measuring chain can sometimes be assigned to the sensor in addition to the actual transducer.

A carrier material is understood to be a substrate on which the NEMS is at least partially structurally mounted. Preferably, the substrate gives the sensor device a dimensionally stable structure so that the sensor device can be used as a single component. A particularly preferred substrate material is a piezoelectric material and/or exhibits piezoelectric behavior. The carrier material can be made up of several different materials, in particular functional materials. Functional materials in this context are materials that are necessary for the function of the sensor device or have positive effects on it, in the sense of improved mechanical strength of the component, sensitivity, efficiency or reproducibility of the measurement. For example, piezoelectric materials, thermally insulating materials, electrically conductive and/or electrically insulating materials, acoustically damping materials. An interdigital transducer structure can be applied to the piezoelectric material of the carrier material, in particular directly.

An interdigital transducer (IDT) is an acoustic transducer that has finger-like structures. An acoustic transducer is a transducer that converts an electrical wave received as an input signal into an acoustic wave and outputs it. The finger-like structures are called interdigital electrodes. They look like fingers or tines of two combs that interlock without touching each other. The finger-like structures are usually made of metal and are arranged on a carrier material, especially a piezoelectric one. If an electrical voltage is applied between the combs, the mechanical force generated (piezo effect) causes a change in the length of the carrier material between each two prongs or fingers. If an alternating voltage is applied, this mechanical force causes the carrier material to vibrate. As a result, surface acoustic waves are generated which propagate on the carrier material. The piezo effect describes the change in electrical polarization and thus the occurrence of an electrical voltage on solids, such as the substrate material, when they are elastically deformed. Conversely, materials deform when an electrical voltage is applied

In the present case, a transmitter is understood to be an acoustic transducer which is set up to emit a transmission signal in the form of a surface wave. The radiation power or transmission power of the transmitter is set up so that the signal propagates as a surface wave at least over a predetermined area of the carrier material and is also set up to excite the mechanical resonators to vibrate.

In the present case, a receiver is understood to be an acoustic transducer which is set up to receive a surface wave as a reception signal. The sensitivity of the receiver is set up to receive a surface wave emitted by the transmitter, which has spread over at least a predetermined area of the carrier material, so that a measurement signal is triggered. Furthermore, the sensitivity of the receiver is designed to receive a surface wave emitted by a mechanical resonator, so that a measurement signal is triggered.

A mechanical resonator, in particular a micro-and/or nano-mechanical resonator, is a mechanical resonator with dimensions in the micro-and/or nanometer range. A resonator is a device or a system capable of oscillation that exhibits resonance or resonance behavior. This means that the resonator oscillates at certain frequencies, known as resonant frequencies, with greater amplitude than at other frequencies. The vibrations in a resonator are mechanical, including acoustic, but can also be electromagnetic, especially in addition. The resonator can be tuned to one or more of the specific frequencies, so-called natural frequencies, in such a way that the resonator essentially only oscillates at these frequencies, particularly with broadband excitation. A mechanical resonator is preferably an acoustically vibrating resonator, i.e. a solid whose atoms are collectively excited to vibrate and is also referred to as a phononic resonator. A solid, in the sense of matter in a solid aggregate state, can be a body composed of several solid bodies. The vibration modes of the body are at least partially predetermined so that they can be made to vibrate via predetermined excitation frequencies, in particular by means of surface acoustic waves. Preferably, a mechanical resonator is set into vibration by the mere mechanical contact between the resonator and the carrier material on which the surface wave propagates. The mechanical resonators can be designed in a wide variety of geometries. Preferred geometries are cylindrical or pillared or rod-shaped or mixtures thereof. The mechanical resonators can be assembled by stacking several cylindrical or pillared or rod-shaped resonators on top of each other and thus form a vibrating system that can be excited to vibrate as a mechanical resonator by means of surface acoustic waves. The mechanical resonators can be constructed and/or composed of one material or several different materials

In the present case, a distance is understood to be a spatial distance, in particular the spatial distance between an interdigital transducer and a mechanical resonator, measured from a point on the interdigital structure of the transducer, for example to the center of the resonator or to its outer wall. If several mechanical resonators are positioned in an area, i.e. within a geometrically definable area, e.g. within a circle or an oval, on the carrier material, the distance between an interdigital transducer and a mechanical resonator is to be understood as the distance that exists between the interdigital transducer and a center point of the area. The center point does not have to be the geometric center of the range, but can be a point that essentially coincides with this center point. For example, a point that roughly corresponds to the center of a circle in a circular area. In this context, the two-dimensional arrangement of the mechanical resonators on the carrier material is referred to as an array, whereby the arrangement of the resonators does not have to exhibit regularity in the sense of equal spacing between the resonators or symmetries. The distance can be determined, for example, by measuring from a finger of the interdigital structure to the outer wall or to the center or symmetry point of the mechanical resonator.

A surface wave is generally understood to be a mechanical deformation of the surface in the form of a wave. In the present case, a surface wave refers in particular to a surface acoustic wave (SAW). A surface acoustic wave is an acoustic wave that propagates along the surface of an elastic material and whose amplitude generally decreases exponentially with the depth of the material, so that it is limited to a depth of approximately one wavelength. The surface acoustic waves, also known as Rayleigh waves, have a longitudinal and a transverse shear component that can couple with any media such as additional layers that are in contact with the surface of the material in which the surface wave propagates. This coupling has a strong effect on the amplitude and velocity of the wave. Surface acoustic waves also include surface acoustic waves, such as Love waves, which are polarized in the plane of the surface and not longitudinally and vertically polarized.

Similar to a Rayleigh wave, Lamb waves in plates also generate a longitudinal and a vertical deflection at the plate surfaces, which is why surface acoustic waves also include applications in which Lamb waves are generated.

In the present case, a transmitted signal is understood to be the surface wave emitted by the transmitter, in particular to the carrier material.

In the present case, a received signal is understood to be a surface wave that is emitted, i.e. emitted by an oscillating resonator, and is suitable for triggering a measurement signal in an acoustic transducer.

A measurement signal is the electrical signal formed by the sensor device, that can be further processed by the sensor device.

In the present case, mechanical vibration is preferably understood as the lattice vibration of a solid body. The solid body is configured as a mechanical resonator and is made to vibrate by means of a surface wave.

An emitted surface wave is an emitted surface wave that has been emitted by an acoustic transducer, for example. Alternatively, an emitted surface wave can also be emitted by a mechanical resonator if it has been set into vibration, for example by an acoustic surface wave.

The sensor device according to the invention offers the advantage that a surface wave emitted by the IDTs as a transmit signal causes the MR to vibrate mechanically and a surface wave emitted by the vibrating MR travels in the direction of the IDTe as a receive signal and triggers a measurement signal in it. This means that no optical measurement technology, such as laser scanning interferometry, is required to detect a displacement field on the mechanical resonator. Thus, there is no restriction on the spatial arrangement of several mechanical resonators within an area on the carrier material, especially not due to electrical lines. Thus, the density of the array of resonators can be advantageously increased, for example to achieve a higher efficiency of the sensor device. The sensor device according to the invention also has the advantage, particular compared to optical measurement techniques, such as laser scanning interferometry, that several mechanical resonators can be measured or read out simultaneously, i.e. together or jointly, and/or that several mechanical resonators can be measured or read out individually, i.e. individually.

In a sensor device according to the invention, at least one interdigital transducer is used as a transmitter and at least one further, spatially separated interdigital transducer is used as a receiver. The distances A, B of the transmitter (IDTs) and/or receiver (IDTe) transducers are set up in such a way that a surface wave transmitted by the IDTs causes at least one mechanical resonator to vibrate mechanically, so that it emits a surface wave and transmits it in the direction of the at least one IDTe, so that the IDTe receives a received signal. The sensor device can have several identical mechanical resonators, or the sensor device can have several different mechanical resonators, or mixed forms of identical and different mechanical resonators. In the case of different resonators, the mechanical resonators oscillate at different frequencies so that they can be distinguished from each other. For example, if an IDT emits a surface wave with frequencies f1 and f2, essentially only these two resonators are excited, which can oscillate at frequencies f1 and f2.

As an alternative sensor device according to the invention, the sensor device can have at least one interdigital transducer which operates as a transmitter and as a receiver. The term bipolar transducer is used synonymously for a transducer operating as a transmitter and as a receiver. The acoustic transducer can first transmit a surface wave as a transmitter in the direction of the at least one mechanical resonator, thus causing the at least one resonator to vibrate mechanically. This causes a surface wave to be generated by the resonator and return in the direction of the transmitter. Since the transmitter is also set up to function as a receiver, the returning surface wave then acts as a receive signal and causes the interdigital structure of the bipolar transducer to vibrate, triggering an electrical voltage as a measurement signal at this bipolar transducer. The sensor device can have several identical mechanical resonators, or the sensor device can have several different mechanical resonators, or mixed forms of identical and different mechanical resonators. In the case of different resonators, the resonators oscillate at different frequencies so that they can be distinguished from one another.

Further, alternative sensor devices according to the invention are those which have mixed forms of bipolar transducer and unipolar transducer. For example, a NEMS according to the invention may have at least one bipolar transducer and at least one unipolar transducer, wherein the at least one unipolar transducer can operate as a transmitter (IDTs) or as a receiver (IDTe). Furthermore, a NEMS according to the invention has at least one bipolar transducer. The sensor device can have several identical mechanical resonators, or the sensor device can have several different mechanical resonators, or mixed forms of identical and different mechanical resonators. In the case of different resonators, the resonators oscillate at different frequencies so that they can be distinguished from one another

In a preferred embodiment, the distance A between an IDTs and the at least one mechanical resonator can be greater or smaller than the distance B between an IDTe. This geometric arrangement of the transducer distances has the advantage that anisotropies in the carrier material can be taken into account, which leads to an improved signal

In a preferred embodiment, the IDTe is arranged on the carrier material (2) in an angular range of 10-360 degrees, preferably in an angular range of 70-110 degrees, more preferably in an angular range of 170-210 degrees, more preferably in an angular range of 250-290 degrees, more preferably in an angular range of 300-350 degrees to the direction of propagation of the surface wave emitted by the IDTs. In a preferred embodiment, the IDTe is arranged on the substrate (2) at an angle of approximately 90 degrees to the direction of propagation of the surface wave emitted by the IDTs. The direction of propagation of the surface wave corresponds to the direction in which the surface wave travels to excite the resonator. The direction of propagation can be described by a straight line or straight section between the at least one resonator and the IDTs, with both being arranged on the carrier material. The line can extend from a freely selectable point on the interdigital structure of the IDTe, for example to the center of the mechanical resonator. The direction of propagation can be determined by a line between the IDTs and the area in which the multiple mechanical resonators are arranged on the carrier material. The line can extend from a freely selectable point on the interdigital structure of the IDTe, for example to the center of the area in which the mechanical resonators are arranged. In particular, the direction of propagation can be the smallest distance between the IDTe and the at least one mechanical resonator and/or the area in which the multiple mechanical resonators are arranged on the carrier material.

An angular range is understood as follows: If two arbitrary points are defined on a circle at which an IDTs and an IDTe are to be arranged on the substrate and these are connected to the center of the circle by lines, whereby a mechanical resonator is arranged in the center, the two parts of the circular area that are separated from each other by these lines represent sections of the circle (also known as the circle sector). In this arrangement, the distance from the IDTs to the center of the circle corresponds to the direction of propagation of the SAW. A circular sector is therefore “cut out” of a circle by two radii, as it were. The part of the circular line belonging to a sector of a circle is called an arc, the angle between the two radii is called the angle range (also known as the center point angle). Instead of a circle, the two arbitrary points can also be defined on an essentially circular, e.g. oval, geometry. For example, the claim wording “in an angular range of 70-110 degrees” can mean that the actual center point angle of the arrangement of the IDTe to the propagation direction is within the range of 70 and 110 degrees. A possible arrangement of the IDTe to the direction of propagation can therefore have a specific value of the center point angle of 80, 90 or 100 degrees in order to be within the angular range of 70-110 degrees.

The 90 degree arrangement has the advantage that a SAW running directly from the IDTs into the IDTe only generates a minimal signal there, as the finger structure of the IDTe is perpendicular or largely perpendicular to the SAW wavefront.

In a particularly preferred embodiment, the mechanical resonator is shaped like a pillar. Other geometries, e.g. a rectangular, a cylindrical, a conical, a stack of disk-shaped segments, or mixed forms of the aforementioned geometries, which are connected to each other by layers or stacks so that they can vibrate, are also possible geometries. A pillared geometry, also known as a pillared resonator, has the advantage that it is the easiest to manufacture and can be described mathematically as a point source

In a preferred embodiment, the pillared resonator has a diameter between 1 nm and 10 μm, preferably between 25 nm and 1 μm, particularly preferably between 50 nm and 200 nm. The diameter D is measured in the plane of the carrier material. With a cylindrical or pillared geometry of the resonator, the diameter corresponds to the geometric diameter of a cylinder, measured in the plane of the carrier material on which the resonator is arranged.

In a preferred embodiment, the pillared resonator has a height of between 10 nm and 10 μm, preferably between 50 nm and 5 μm, particularly preferably between 200 nm and 2 μm. The height H corresponds to the expansion of the resonator in a direction perpendicular to the substrate on which the resonator is arranged.

In a preferred embodiment, the carrier material has a piezoelectric material or consists of a piezoelectric material, in particular lithium niobate (LiNbO₃) or quartz (SiO₂) or zinc oxide (ZnO) or aluminum nitride (AlN), or zirconate titanate (PZT), or lithium tantalate (LiTaO₃), or mixed forms thereof. Lithium niobate (LiNbO₃) has the advantage that it has a high piezoelectric coupling constant compared to other piezoelectric materials and therefore leads to good signal quality.

In a preferred embodiment, the IDTs and/or the IDTe is designed as a focusing, in particular interdigital, transducer. In this case, the transducer can have an at least partially conical or arrow-shaped geometry; in particular, the transducer can be conical or arrow-shaped in its entirety. In particular, the interdigital structure of the transducer is curved at least in sections. However, the transducer can also have a rectangular geometry. A conical, in particular focusing geometry has the advantage that the surface acoustic waves propagate with a higher intensity in a preferred direction, e.g. in the direction of the resonators. Further preferably, the at least one transducer set up as a transmitter can be a focusing transducer. Further preferably, the one or more transducers set up as transmitters may be set up as focusing transducers and the at least one transducer set up as a receiver may be set up as non-focusing. Further preferably, the one or more transducers set up as receivers can be set up as focusing transducers and the at least one transducer set up as a transmitter can be set up as non-focusing.

In a preferred embodiment, the IDTs and/or the IDTe has a finger width between 50 nm and 20 μm, preferably between 200 nm and 10 μm, particularly preferably between 1 μm and 5 μm. A finger width is understood to be the width of a finger of the interdigital structure, measured in a direction parallel to the carrier material on which the interdigital structure is arranged.

In a preferred embodiment, at least one interdigital transducer comprises or consists of aluminum, or silver, or gold, or platinum, or copper, or nickel, or titanium, or niobium, or mixtures thereof, to form the interdigital structure.

In a preferred embodiment, A has a value between 50 μm and 2000 μm and B has a value between 50 μm and 2000 μm, preferably A has a value between 150 μm and 1500 μm and B has a value between 150 μm and 1500 μm, further preferably A has a value between 300 μm and 1000 μm and B has a value between 300 μm and 1000 μm. The values of A and B should also be able to lie within the defined ranges. For example, A can have a value of 50 μm or 200 μm and is therefore within the specified range between 50 μm and 2000 μm.

In a preferred embodiment of the sensor device, at least one electrode is arranged on the carrier material next to an interdigital transducer. The term “next to” is to be understood as meaning that if two transducers are arranged next to or adjacent to each other, no further transducer is arranged between them. In particular, at least one electrode can be arranged on the carrier material between neighboring interdigital transducers. Due to the interdigital structure of the transducers, they act as antennas, which is why electrical signals from outside the sensor device are also received by them and lead to signal noise. The arrangement of the electrodes between neighboring transducers has the advantage that the resulting signal noise is at least partially suppressed and thus the signal-to-noise ratio of the sensor device is improved.

Furthermore, the invention relates to a system comprising a sensor device according to the invention. The system according to the invention comprises a control unit for controlling at least one IDTe and an evaluation unit for evaluating a measurement signal of the at least one IDTe, wherein preferably the control unit outputs an electrical signal to at least one IDTs for generating a surface wave as a transmit signal and the transmit signal causes the at least one mechanical resonator to vibrate and a surface wave emitted by the at least one vibrating MR travels as a receive signal in the direction of the at least one IDTe and triggers the measurement signal in the latter, wherein the measurement signal is preferably processed by the evaluation unit, in particular the measurement signal of the at least one IDTe is tracked for a change in an amplitude signal (17) at a resonance frequency (14) predetermined by the at least one mechanical resonator (5). The control unit and the evaluation unit may be different devices or may be combined in the same device. Such combined devices are typically lock-in amplifiers or network analyzers.

In a preferred embodiment of the system, the system is set up to track the frequency, in particular the resonant frequency and the amplitude, using an oscillator circuit, such as a phase-locked loop (PLL) or self-sustaining oscillator (SSO). The PLL and the SSO are closed-loop circuits that drive individual resonators coherently at a defined resonance frequency and with a defined amplitude, thus causing them to oscillate. The oscillation frequency of this NEMS resonant circuit is identical to the resonant frequency of the resonator and allows changes in the resonant frequency and amplitude to be tracked in real time. Such resonant circuits can be operated simultaneously for several resonators.

Furthermore, the invention relates to a method of manufacturing a sensor device according to the invention, wherein the method comprises the following steps:
A) Providing a carrier material, in particular a piezoelectric one;
B) Application of the first IDT arrangement or the second IDT arrangement to the carrier material;
C) Application of at least one mechanical resonator to the carrier material,
wherein step B can optionally be carried out by at least the following steps:
   a. Application of a metal layer on the carrier material to form an interdigital structure of at least one interdigital transducer serving as transmitter (IDTs) and as receiver (IDTe) according to the first IDT arrangement; OR Application of a metal layer to the carrier material to form an interdigital structure of at least one interdigital transducer which serves as a transmitter (IDTs) and at least one interdigital transducer which serves as a receiver (IDTe), according to the second IDT arrangement;
   b. Forming the interdigital structure of the at least one IDT on the carrier material, preferably by means of:
      Photolithography and etching process; or
      by means of photolithography and lift-off process,
         wherein step C can optionally be carried out by at least one of the following steps:
Focused Electron Beam Induced Deposition (FEBID),
Photolithography and physical vapor deposition (PVD), or
Photolithography and chemical vapor deposition (CVD), or
Photolithography and vapor deposition or atomization process (sputtering), or
Ion-Beam Induced Deposition (IBID), or
Wet or dry etching into the substrate, or
Structuring of photoresists, in particular structuring of SU-8, or
Metal-Organic Vapor Phase Epitaxy.

Further preferred embodiments of the sensor device according to the invention and of the method for its manufacture, as well as of the system of the invention, result from the following description of the embodiments in connection with the figures and their description. Identical components are essentially identified by identical reference signs, unless otherwise described or unless otherwise apparent from the context.

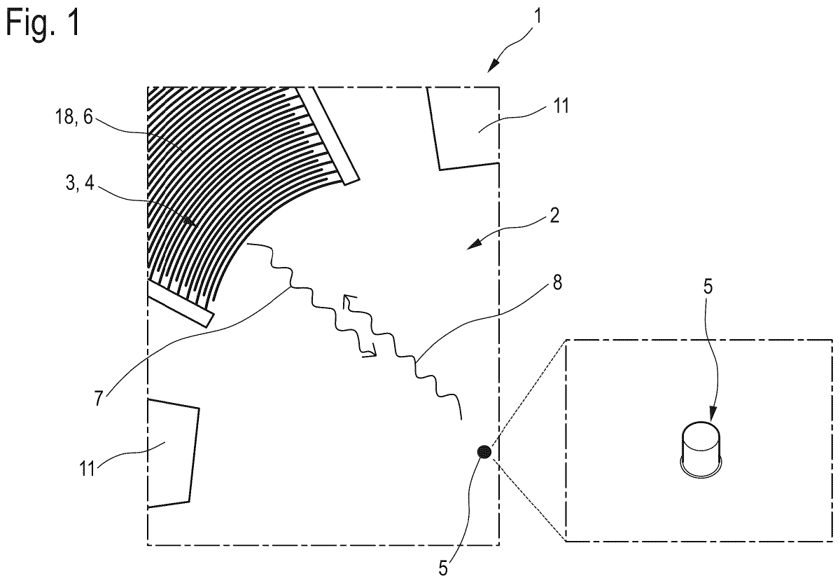

FIG. 1 shows a first embodiment of the sensor device 1 according to the invention

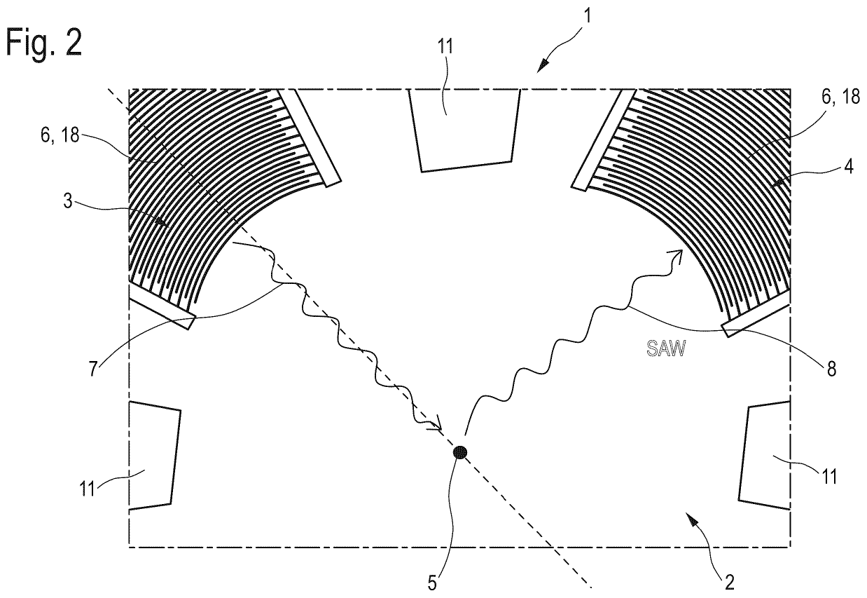

FIG. 2 shows a second embodiment of the sensor device 1 according to the invention.

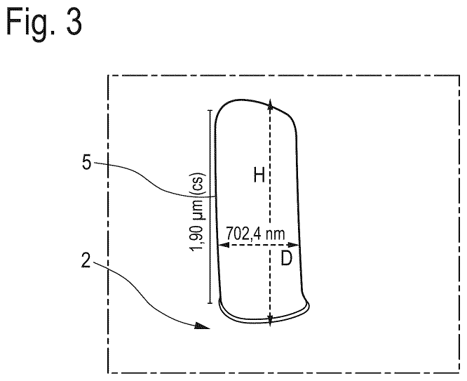

FIG. 3 shows an electron micrograph of an embodiment of a mechanical resonator 5 of the sensor device 1 according to the invention.

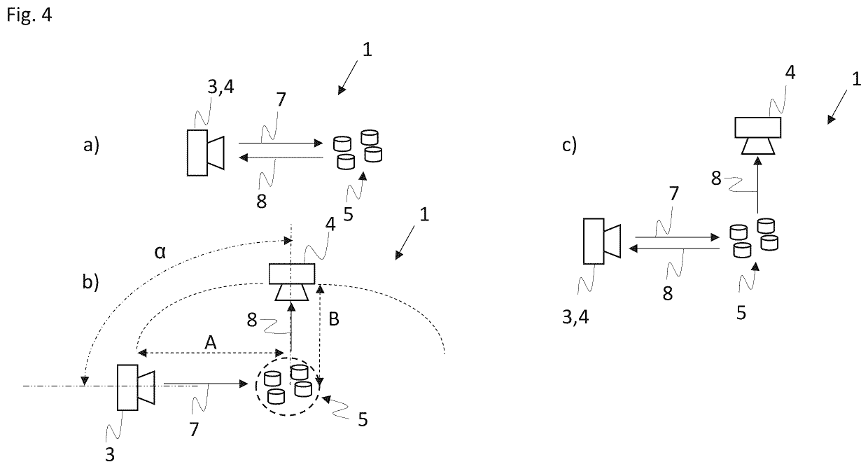

FIG. 4 a-c schematically show embodiments of the sensor device 1 according to the invention.

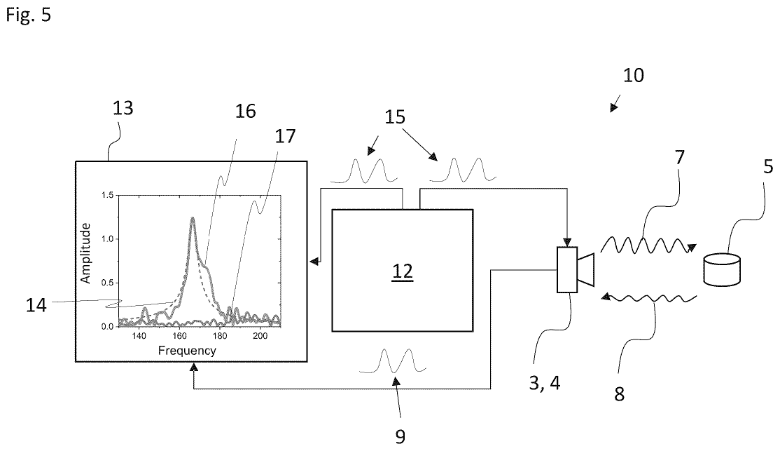

FIG. 5 schematically shows an embodiment of the system 10 according to the invention.

FIG. 1 shows a first embodiment of the sensor device 1 according to the invention on a carrier material 2, using the first IDT arrangement. In FIG. 1, an interdigital structure 6, 18 of an acoustic transducer (IDT) 3, 4 is shown starting from the upper left edge of the image. The interdigital structure of the transducer 3, 4 is curved so that the transducer has a conical shape which is aligned in the direction of the mechanical resonator 5 so that a surface wave emitted as a transmitted signal 7 is focused on the mechanical resonator 5. In addition, FIG. 1 shows an electron microscope view of a cylindrical mechanical resonator 5 next to the sensor device 1 shown. The mechanical resonator 5, as well as the transducer 3, 4 serving as transmitter and receiver in FIG. 1, are arranged on the substrate 2. A surface wave emitted by the mechanical resonator 5 as a received signal 8 is also shown. In this particularly preferred embodiment shown in FIG. 1, only one bipolar transducer 3, 4 is required to generate and detect a mechanical oscillation of the mechanical resonator 5 shown. The sensor device also has two electrodes 11. The electrodes 11 are arranged on the substrate 2 and positioned directly adjacent to the transducer 3, 4. The electrodes 11 have the task of preventing, in particular, high-frequency electrical coupling of external sources into the sensor device 1. This has the advantage that an improved signal quality can be achieved, as electrical coupling can negatively influence the noise-to-signal ratio of the measurement signal 9.

FIG. 2 shows a second embodiment of the sensor device 1 according to the invention, whereby FIG. 2 essentially differs from FIG. 1 in that two unipolar transducers (IDT) 3, 4 are arranged on the substrate 2, i.e. the second IDT arrangement is used. FIG. 2 also shows a dashed line. This line runs centrally between the transducer acting as transmitter 3 and the mechanical resonator 5. The receiver transducer 4 is positioned at an angle (not shown) of approx. 90 degrees to this dashed line, so that a surface wave emitted by the vibrating mechanical resonator 5 as a received signal 8 runs in the direction of the receiver 4 and triggers a measurement signal 9 there. The sensor device also has three electrodes 11. The electrodes 11 are arranged on the substrate 2 and positioned adjacent to the two transducers 3, 4. The electrodes 11 have the task of preventing, in particular, high-frequency electrical coupling of external sources into the sensor device 1 and crosstalk from the transducer acting as transmitter 3 (IDTs) to the receiver transducer 4 (IDTe). Electrical coupling or crosstalk can have a negative effect on the noise-to-signal ratio of the measurement signal 9. The use of electrodes 11 has the advantage that an improved signal quality can be achieved.

FIG. 3 shows an electron micrograph of an embodiment of a mechanical resonator 5 of the sensor device 1 according to the invention. The mechanical resonator 5 is designed here in the form of a pillared, or pillared resonator. The mechanical resonator 5 is applied directly to the substrate surface of the substrate 2 so that it can vibrate. The pillared resonator shown has a height H measured perpendicular to the surface of the substrate 2 (longitudinal extension) of approx. 1.9 μm and a diameter D or a width, measured horizontally to the surface of the substrate 2 of 702.4 nm. The height H and the diameter D are each shown by dashed lines in FIG. 3.

FIG. 4 a-c show schematic embodiments of the sensor device 1 according to the invention. FIG. 4a shows the embodiment shown in FIG. 1, in which a single bipolar transducer (IDT) 3, 4, i.e. the first IDT array, is used. A large number of mechanical resonators 5 with uniform geometry are shown arranged within an area to form an array. A transmit signal 7 is emitted in the direction of the mechanical resonators 5 and causes them to vibrate mechanically. A receive signal 8 is emitted by the vibrating mechanical resonators 5. The mechanical resonators 5 can have different geometries. In particular, the resonators can have different geometries that are set up to realize different resonant frequencies of the individual mechanical resonators 5.

FIG. 4b schematically shows the embodiment shown in FIG. 2. Two unipolar transducers are used as receivers 4 or transmitters 3. Furthermore, a number of mechanical resonators 5 with the same, i.e. uniform, geometry are shown, which are arranged as an array within a circular area shown as a dashed line. These mechanical resonators 5 can have same resonance behavior, i.e. essentially the same resonance frequencies, or different resonance behavior, i.e. essentially different resonance frequencies. The transmitter 3 is positioned at a distance A from the center of the circular area. The receiver 4 is positioned at a distance B from the center of the circular area. If the distances are different as shown in FIG. 4b, i.e. A is greater than B, this results in an oval contour, which is shown as a dashed line in FIG. 4b. The transmitter 3 and the receiver 4 are positioned along this contour. With such an arrangement, the signal strength of the surface acoustic waves picked up at the receiver is particularly high. The angle α of 90 degrees of the angle range of 70-110 degrees is indicated by a dashed line with arrows on the left in FIG. 3b, perpendicular to the direction of propagation of the SAW of the ITD 3, which is drawn with a dotted line and coincides with the direction of the transmitted signal 7.

FIG. 4c schematically shows an embodiment in which a bipolar 3, 4 and a unipolar 4 transducer are used. A surface wave emitted by the transmitter 3 in the direction of the mechanical resonators 5 as a transmission signal 5 is received both by the bipolar transducer 3, 4 and by the unipolar receiver arranged at 90 degrees to it. This allows a first and a second measurement signal 9 to be output. In such an embodiment, the bipolar transducer 3, 4 can additionally be designed as a focusing transducer, i.e. conical. The unipolar transducer 4 can have a rectangular outer geometry or also be designed to be focusing, in particular conical. Mixed forms of arrangements of focusing and non-focusing transducers on the carrier material 2 are also possible.

FIG. 5 schematically shows an embodiment of the system 10 according to the invention. The system has a sensor device 1, a control unit 12 and an evaluation unit 13. The control unit 12 sends an electrical signal 15 to the bipolar transducer 3, 4 of the sensor device 1, which is also sent to the evaluation unit 13 as a reference signal. The bipolar transducer 3, 4 then emits a surface wave emitted as a transmission signal 7 in the direction of the resonator 5. This is set into resonance by the transmit signal 7 and then emits a surface wave as a receive signal 8 in the direction of the bipolar transducer 3, 4. The transducer 3, 4 receives the receive signal 8 and converts it into a measurement signal 9. The measurement signal 9 is transmitted to the evaluation unit 13 by the transducer 3, 4. The evaluation unit 13 determines the amplitude and phase of the measurement signal 9 as a function of the frequency. The relevant frequency range is determined by the natural frequency of the resonator 5. If the resonator 5 is excited by the emitted surface acoustic waves in its natural frequency range, this results in the amplitude signal 16, which has a resonance peak. If there is no excitation, this results in the noisy amplitude signal 17 shown in FIG. 5, without a resonance peak. The amplitude signal 14 shown as a dashed line corresponds to a fit based on the model of a one-dimensional and driven linear resonator. The natural frequency of the resonator can be predetermined by its geometric shape, allowing the sensor device 1, i.e. its resonance behavior, to be tuned to a specific measurement task.

### LIST OF REFERENCES

1 Sensor device
2 Carrier material
3 Interdigital transducer as transmitter
4 Interdigital transducer as receiver
5 Mechanical resonator
6 Interdigital structure
7 Surface wave as transmission signal
8 Surface wave as received signal
9 Measuring signal
10 System
11 Electrodes
12 Control unit
13 Evaluation unit
14 Theoretical amplitude signal at resonant frequency
15 Electrical transmission signal
16 Amplitude signal at resonance
17 Amplitude signal without resonance effect
18 Finger width of the interdigital structure

1. A sensor device for measuring surface acoustic waves, comprising a carrier material, in particular a piezoelectric carrier material,
with at least a first interdigital transducer (IDT) arrangement or a second IDT arrangement,
wherein the first IDT arrangement comprises at least one interdigital transducer, which is configured as an IDT transmitter (IDTs) and as an IDT receiver (IDTe) and which is arranged on the carrier material,
and wherein the second IDT arrangement comprises at least one interdigital transducer, which is configured as an IDT transmitter, and at least one interdigital transducer, which is configured as an IDT receiver, and which are arranged on the carrier material,
wherein the sensor device comprises at least one mechanical resonator (MR), which is arranged on the carrier material at a distance A from the IDTs and at a distance B from the IDTe,
wherein the sensor device is configured so that an acoustic surface wave emitted by the IDTs causes the MR to vibrate mechanically as a transmit signal and a surface wave emitted by the vibrating MR travels in the direction of the IDTe as a receive signal and generates a measurement signal in the latter.

2. The sensor device according to claim 1, wherein the distance A is greater than or less than the distance B.

3. The sensor device according to claim 1, wherein the IDTe is arranged in an angular range of 10-360 degrees to the direction of propagation of the surface wave emitted by the IDTs on the carrier material.

4. The sensor device according to claim 1, wherein the MR is of pillared design.

5. The sensor device according to claim 4, wherein the pillared MR comprises a diameter between 1 nm and 10 μm.

6. The sensor device according to claim 4, wherein the pillared MR comprises a height between 10 nm and 10 μm.

7. The sensor device according to claim 1, wherein the carrier material comprises a piezoelectric material, in particular lithium niobate (LiNbO₃) or quartz (SiO₂) or zinc oxide (ZnO) or aluminum nitride (AlN), or zirconate titanate (PZT), or lithium tantalate (LiTaO₃), or mixtures thereof.

8. The sensor device according to claim 1, wherein the IDTs and/or the IDTe are configured as focusing interdigital transducers.

9. The sensor device according to claim 1, wherein the IDTs and/or the IDTe comprise a finger width between 50 nm and 20 μm.

10. The sensor device according to claim 1, wherein the interdigital transducer comprises aluminum, or silver, or gold, or platinum, or copper, or nickel, or titanium, or niobium, or mixtures thereof, for forming the interdigital structure.

11. The sensor device according to claim 1, wherein A comprises a value between 50 μm and 2000 μm and B comprises a value between 50 μm and 2000 μm.

12. The sensor device according to claim 1, wherein at least one electrode is arranged on the carrier material in addition to an interdigital transducer.

13. A system comprising a sensor device according to claim 1, an control unit for actuating at least one IDT and an evaluation unit for evaluating a measurement signal of the at least one IDT, wherein the control unit outputs an electrical signal to at least one IDT for generating the surface wave serving as a transmission signal and the transmission signal causes the at least one mechanical resonator to vibrate and wherein the evaluation unit processes the measurement signal of the at least one IDTe.

14. The system according to claim 13, wherein the system is configured to track the frequency and the amplitude of the measurement signal and wherein in particular this tracking of the change in amplitude and frequency of the measurement signal is carried out according to a phase-locked loop (PLL) method or according to a self-sustaining oscillator method (SSO).

15. A method of manufacturing a sensor device according to claim 1, comprising the following steps:
A) Providing a carrier material, in particular a piezoelectric one;
B) Application of the first IDT arrangement or the second IDT arrangement to the carrier material;
C) Application of at least one mechanical resonator to the carrier material
wherein step B can optionally be carried out by at least the following steps:
a. Application of a metal layer to the carrier material to form an interdigital structure of at least one interdigital transducer which serves as transmitter (IDTs) and as receiver (IDTe), according to the first IDT arrangement; OR
Application of a metal layer to the carrier material to form an interdigital structure of at least one interdigital transducer which serves as a transmitter (IDTs) and at least one interdigital transducer which serves as a receiver (IDTe), according to the second IDT arrangement;
b. Forming the interdigital structure of the at least one IDT on the carrier material, preferably by means of:
Photolithography and etching process; or
by means of photolithography and lift-off process,
wherein step C can optionally be carried out by at least one of the following steps:
Focused Electron Beam Induced Deposition (FEBID),
Photolithography and physical vapor deposition (PVD), or
Photolithography and chemical vapor deposition (CVD), or
Atomization process (sputtering), or
Ion-Beam Induced Deposition (IBID), or
Wet or dry etching into the carrier material, or
Structuring of photoresists, in particular structuring of SU-8, or
Metal-Organic Vapor Phase Epitaxy.
